(19) United States
(12) Patent Application Publication
(10) Pub. No.: US 2008/0204468 A1
(43) Pub. Date: Aug. 28, 2008

(54) Graphics processor pipelined reduction operations

(76) Inventors: Wenlong Li, Beijing (CN); Eric Li, Beijing (CN)

Correspondence Address: RYDER IP LAW;C/O INTELLEVATE, LLC, P. O. BOX 52050, MINNEAPOLIS, MN, 55402, US

(21) Appl. No.: 11/712,122

(22) Filed: Feb. 28, 2007

(51) Int. Cl. G09G 5/00

(52) U.S. Cl. 345/582

(57) ABSTRACT

In general, in one aspect, the disclosure describes a method to initialize a texture buffer and pipeline reduction operations by utilizing the texture buffer.

### BACKGROUND

A graphics processing unit (GPU) is a dedicated graphics rendering device that may be used with, for example, personal computers, workstations, or game consoles. GPUs are very efficient at manipulating and displaying computer graphics. GPUs contain multiple processing units that that concurrently perform independent operations (e.g., color space conversion at pixel level). Their highly parallel structure may make them more effective than a typical central processing unit (CPU) for a range of complex algorithms. A GPU may implement a number of graphics primitive operations in a way that makes running them much faster than drawing directly to the screen with the host CPU.

General purpose programming on a GPU is becoming an effective and popular way to accelerate computations, and serves as an important computational unit in conjunction with a CPU. In practice, a large number of existing general purpose processing kernels (e.g., texture processing, matrix and vector computation) may be optimized for running on a GPU. However, the GPU has some hardware constraints and structural limitations. For example, the GPU has no global variable concept and can't use several global variables to save temporal data on the fly. Accordingly, the GPU may not efficiently handle some commonly used reduction operations (e.g., average and sum computations over a bunch of data elements).

### BRIEF DESCRIPTION OF THE DRAWINGS

The features and advantages of the various embodiments will become apparent from the following detailed description in which:

FIG. 1 illustrates an example video mining application, according to one embodiment;

FIG. 2A illustrates a flow diagram for an example filter loop method for reduction operations, according to one embodiment;

FIG. 2B illustrates an example application of the filter loop method, according to one embodiment;

FIG. 3A illustrates a flow diagram for an example pipeline texture method for reduction operations, according to one embodiment; and

FIG. 3B illustrates an example application of the pipeline texture loop method, according to one embodiment.

### DETAILED DESCRIPTION

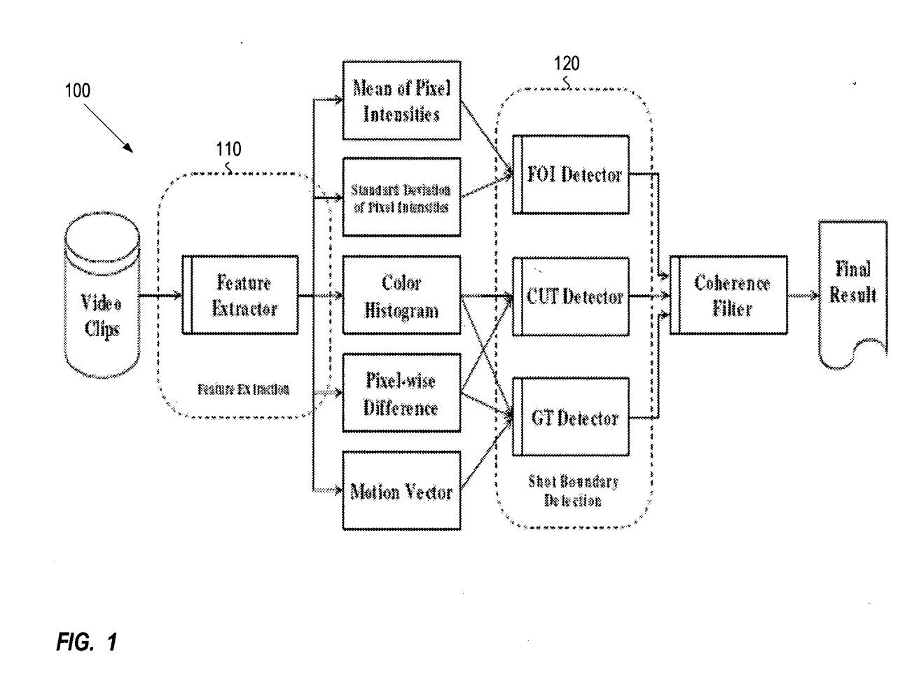

FIG. 1 illustrates an example video mining application 100. The video mining application 100 includes feature extraction 110 and shot boundary detection 120. The feature extraction 110 includes several reduction operations. The reduction operations may include, at least some subset of (1) determining average gray value of all pixels within a frame; (2) extracting black and white values of pixels within a specified region; (3) computing a RGB histogram for each color channel of a frame; and (4) computing average gray difference value for two consecutive frames.

Feature extraction may be performed on by downscaling a frame (e.g., 720×576 pixels) into smaller blocks in a hierarchical fashion and extracting the features for the blocks. The frame is eventually reduced to 1 pixel and the pixel is an average value for the frame.

A blocked method entails downsizing the frame in large blocks using large filters. For example, a 720×576 pixel frame may be downsized to a 20×18 pixel image using a 36×32 filter shader and then the 20×18 pixel image may be downscaled into a single pixel using a 20×18 filter shader. This method requires only a few steps (e.g., two downsizing events) but the steps may require significant memory access time. Utilizing such a method on a GPU that has a plurality of independent processing units (pipelines), may result in one pipeline hogging access to memory resulting in other pipelines stalling.

A filter loop method entails utilizing one filter shader several times to continually downsize the frame a certain amount and then once the image has been reduced to a certain size utilizing a second filter shader to reduce to 1 pixel. This method uses multiple pixel buffers for each frame to hold the various downsized versions. For example, a 2×2 filter may be used to ¼ the image 5 times thus reducing the image to 22×18 pixels. The 22×18 pixel image may then be downsized to 1 pixel using a 22×18 filter shader. This example may require 5 pixel buffers to store the various downsized images (each ¼ sized image).

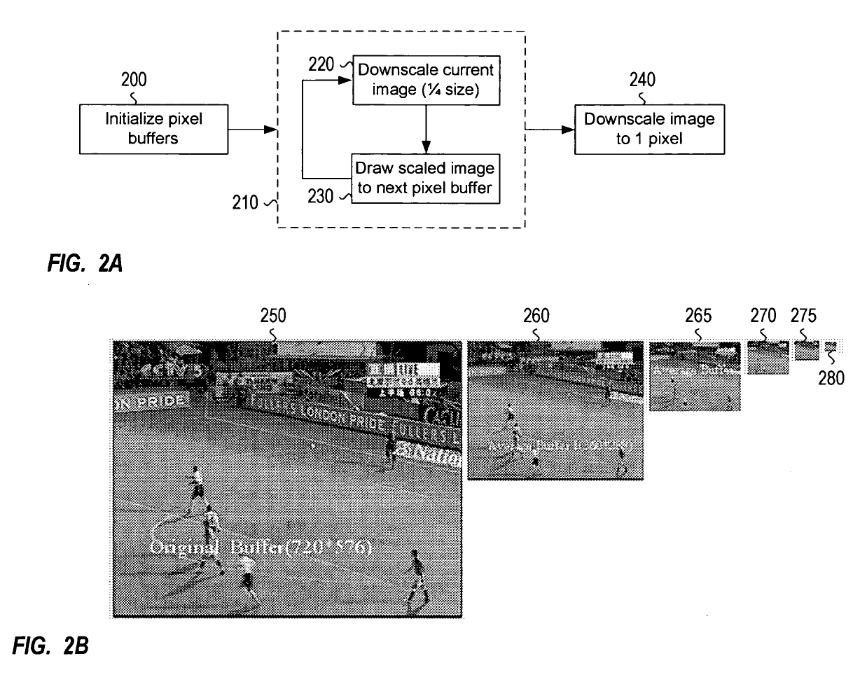

FIG. 2A illustrates a flow diagram for an example filter loop method for reduction operations. The pixel buffers (e.g., 5) are initiated (200). The frame is provided to a down sizing loop (210). The loop 210 downscales current image to ¼ size by utilizing a 2×2 filter (220). The scaled image is drawn to the next pixel buffer (230). The loop 210 ends when the current image is 22×18 pixels (e.g., after five ¼ down sizings). The 22×18 pixel image is then reduced to 1 pixel using a 22×18 filter shader (240). The result for the one pixel is the expected average value for the frame.

The filter loop method requires six downsizing operations for each frame and requires five additional pixel buffers to capture the downsized images. The critical path in the filter loop method is the downsizing utilizing the 22×18 filter shader.

FIG. 2B illustrates an example application of the filter loop method (e.g., 210). The frame is stored in a buffer 250 when it is received. The frame is downsized by ¼ and then stored in a next buffer 260. The downsized images are then downsized and stored in successive buffers 265-280. The imaged stored in buffer 280 is the 22×18 pixel image that is downsized to 1 pixel with a 22×18 filter shader.

A pipeline texture approach overlaps down scaling operations for various frames to increase parallelism. Multiple filtering steps are merged into a single filtering step so that multiple (e.g., 8) continuous frames with different size will be down scaled together. Initially a texture buffer that is larger (e.g., 2 times) than a fame is initialized. The texture buffer may include two sides, one side for storing a new frame and a second side for storing downscaled frames. A frame is read into the texture buffer. The texture buffer is then downsized and the downsized image is shifted. This process continues so that filtering operations are downscaling multiple frames at once. Once the operation is in steady state (the texture buffer is full) performing a single down scale is enough to obtain the final result.

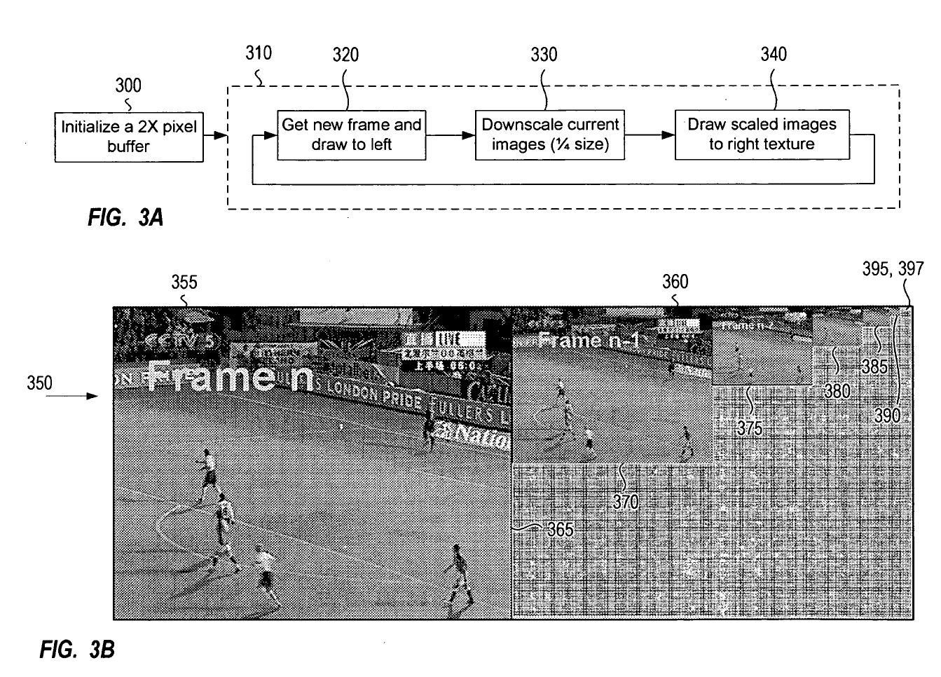

FIG. 3A illustrates a flow diagram for an example pipeline texture method for reduction operations. A 2× pixel buffer is initialized (300). A pipeline filter operation (310) is then initiated. The pipeline filter operation 310 includes reading a new frame and drawing it to the left side of the texture (320). The images in the texture are then downscaled by ¼ using a 2×2 filter (330) and all of the downscaled images are drawn to right side of the texture (340). In effect each image in the texture is downsized and then shifted to the right. The original frame (e.g., 720×576 pixels) is downsized by ¼ (e.g., 360×288 pixels) and drawn to the first location on the right side of the texture buffer. Images on the right side of the texture are downsized and then redrawn to the next location on the right side.

The process of downsizing is continually repeated. Each downsized operation downsizes a new frame and the downsized images in the right side of the texture buffer together. It takes seven ¼ downsizing operations to reduce a frame to a single pixel. The right side of the texture buffer can hold seven downscaled images. When full, the texture buffer holds a total of eight frames in varying downscaled versions and downscales each of these images together. The value after the 7^{th} downsizing operation is one pixel and represents the expected average value for the frame.

FIG. 3B illustrates an example application of the pipeline texture loop method (e.g., 310). A texture buffer 350 is twice the size as a frame (e.g., 1440×576 pixels) and includes a left side 355 and a right side 360. The left side 355 stores a new frame (frame N) 365. The right side 360 stores seven downscaled versions of previous frames. The previous frame (frame N-1) 370 is ¼ size and is stored in the first slot on the right side 360. Frame N-2 375 through frame N-7 397 are stored in successive slots on the right side and each is ¼ the size of the previous slot. It should be noted that frames N-6 and N-7 are of such a small size that they not clearly visible and are therefore labeled together for ease).

When a downsize operation is performed it reduces 7 images (various stages of seven different frames) together and redraws the images on the right side and then draw a new frame on the left side. Accordingly, when the pipeline texture method is in steady state each reduction operation will produce a result for one frame.

Utilizing the pipeline texture method on a GPU enables processing multiple computations for multiple frames at the same time. Such processing could not be performed on a CPU without sophisticated programming and SIMD optimization.

The texture buffer embodiments described above discussed the buffer being twice as long as a frame in length (e.g., 720×576 to 1440×576) but is not limited thereto. Rather the buffer could be extended by height (e.g., 720×1152) without departing from the scope. Moreover, the embodiments showed a new frame being drawn to the left and downsized frames being drawn to the right but is not limited thereto. Rather, the new frame could be drawn to the right with downsized frames drawn to the left, the new frame could be drawn to the top and downsized frames drawn below, or new frames could be drawn to the bottom and downsized frames drawn above without departing from the scope. It is simply the fact that one downsizing operation is being performed on everything in the buffer and then the downsized images are redrawn to next location in buffer.

Although the disclosure has been illustrated by reference to specific embodiments, it will be apparent that the disclosure is not limited thereto as various changes and modifications may be made thereto without departing from the scope. Reference to “one embodiment” or “an embodiment” means that a particular feature, structure or characteristic described therein is included in at least one embodiment. Thus, the appearances of the phrase “in one embodiment” or “in an embodiment” appearing in various places throughout the specification are not necessarily all referring to the same embodiment.

An embodiment may be implemented by hardware, software, firmware, microcode, or any combination thereof. When implemented in software, firmware, or microcode, the elements of an embodiment are the program code or code segments to perform the necessary tasks. The code may be the actual code that carries out the operations, or code that emulates or simulates the operations. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc. The program or code segments may be stored in a processor readable medium or transmitted by a computer data signal embodied in a carrier wave, or a signal modulated by a carrier, over a transmission medium. The “processor readable or accessible medium” or “machine readable or accessible medium” may include any medium that can store, transmit, or transfer information. Examples of the processor/machine readable/accessible medium include an electronic circuit, a semiconductor memory device, a read only memory (ROM), a flash memory, an erasable ROM (EROM), a floppy diskette, a compact disk (CD-ROM), an optical disk, a hard disk, a fiber optic medium, a radio frequency (RF) link, etc. The computer data signal may include any signal that can propagate over a transmission medium such as electronic network channels, optical fibers, air, electromagnetic, RF links, etc. The code segments may be downloaded via computer networks such as the Internet, Intranet, etc. The machine accessible medium may be embodied in an article of manufacture. The machine accessible medium may include data that, when accessed by a machine, cause the machine to perform the operations described in the following. The term “data” here refers to any type of information that is encoded for machine-readable purposes. Therefore, it may include program, code, data, file, etc.

All or part of an embodiment may be implemented by software. The software may have several modules coupled to one another. A software module is coupled to another module to receive variables, parameters, arguments, pointers, etc. and/or to generate or pass results, updated variables, pointers, etc. A software module may also be a software driver or interface to interact with the operating system running on the platform. A software module may also be a hardware driver to configure, set up, initialize, send and receive data to and from a hardware device.

An embodiment may be described as a process which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process, is terminated when its operations are completed. A process may correspond to a method, a function, a procedure, a subroutine, a subprogram, etc. When a process corresponds to a function, its termination corresponds to a return of the function to the calling function or the main function.

The various embodiments are intended to be protected broadly within the spirit and scope of the appended claims.

What is claimed:

1. A method comprising
initializing a texture buffer; and
pipelining reduction operations by utilizing the texture buffer.

2. The method of claim 1, wherein said pipelining includes
drawing a new frame to the texture buffer;
downscaling current images in the texture buffer; and
drawing downscaled images to the texture buffer.

3. The method of claim 2, wherein said pipelining is repeated for a frame until it is reduced to one pixel.

4. The method of claim 2, wherein said downscaling downscales each image to ¼ size.

5. The method of claim 4, wherein said downscaling downscales seven images together.

6. The method of claim 2, wherein the texture buffer is twice the size of a frame.

7. The method of claim 2, wherein the new frame is drawn to a first portion of the texture buffer.

8. The method of claim 2, wherein downscaled images are drawn to a second portion of the texture buffer.

9. The method of claim 2, wherein each downsizing operation will produce a result for one frame when in steady state.

10. The method of claim 9, wherein the result is an expected average value for reduction operations on the frame.

11. A machine-accessible medium comprising content, which, when executed by a machine causes the machine to:
initialize a texture buffer; and
pipeline reduction operations by utilizing the texture buffer.

12. The machine-accessible medium of claim 11, wherein the content causing the machine to pipeline
draws a new frame to the texture buffer;
downscales current images in the texture buffer; and
draws downscaled images to the texture buffer.

13. The machine-accessible medium of claim 12, wherein when executed the content causing the machine to pipeline repeats for a frame until it is reduced to one pixel.

14. The machine-accessible medium of claim 12, wherein the content causing the machine to downscale downscales seven images together and downscales each image to ¼ size.

15. The machine-accessible medium of claim 12, wherein when executed the content causing the machine to pipeline will produce an expected average value for reduction operations for one frame for each iteration when in steady state.

16. A system comprising
a central processing unit (CPU);
a graphics processing unit (GPU); and
memory coupled to the CPU and the GPU to store an application, the application when executed causing the GPU to
initialize a texture buffer; and
continually
draw a new frame to the texture buffer;
downscale current images in the texture buffer; and
draw downscaled images to the texture buffer.

17. The system of claim 16, wherein the application when executed causes the GPU to downscale seven images together and downscale each image to ¼ size.

18. The system of claim 16, wherein the application when executed causes the GPU to produce an expected average value for reduction operations for one frame for each iteration when in steady state.
